(19) United States
(12) Patent Application Publication
(10) Pub. No.: US 2025/0140235 A1
(43) Pub. Date: May 1, 2025

(54) CENTRAL VOICE MODEL SERVER FOR A VOICE CONTROLLED TERMINAL AND OPERATING METHOD FOR A CENTRAL VOICE MODEL SERVER

(71) Applicant: Deutsche Telekom AG, Bonn (DE)

(72) Inventors: Jascha MINOW, Bensheim (DE); Carl JAHN, Wiesbaden (DE); Said EL MALLOUKI, St. Goar (DE)

(21) Appl. No.: 18/925,205

(22) Filed: Oct. 24, 2024

(30) Foreign Application Priority Data
Oct. 25, 2023 (EP) 23 205 867.7

(51) Int. Cl. G10L 13/027

(52) U.S. Cl. CPC G10L 13/027

(57) ABSTRACT

A method for operating a central voice model server for a voice-controlled terminal includes: by a voice-controlled terminal, capturing a voice command of a user of the voice-controlled terminal and transmitting a primary audio file comprising the captured voice command to a central voice model server associated with the voice-controlled terminal; by a voice control of the voice-controlled terminal, recognizing the voice command in the provided primary audio file using a voice model received from the central voice model server and causing a reaction of the terminal corresponding to the recognized voice command; synthetically generating, by a synthesis module of the central voice model server, respective secondary audio files from randomly designated groups of primary audio files stored in a buffer memory; training the voice model exclusively with the generated secondary audio files; and transmitting, by the central voice model server, the trained voice model to the voice-controlled terminal.

### CROSS REFERENCE TO RELATED APPLICATIONS

This application claims benefit to European Patent Application No. EP 23 205 867.7, filed on Oct. 25, 2023, which is hereby incorporated by reference herein.

### FIELD

The invention relates to a method for operating a central voice model server for a voice-controlled terminal, in which a voice-controlled terminal captures a voice command of a user of the voice-controlled terminal and transmits a primary audio file comprising the captured voice command to a central voice model server associated with the voice-controlled terminal, a voice control of the voice-controlled terminal recognizes the voice command in the provided primary audio file by means of a voice model received from the central voice model server and causes a reaction of the terminal corresponding to the recognized voice command. The invention further relates to a central voice model server for a voice-controlled terminal and a computer program product.

### BACKGROUND

Voice command means an audibly perceptible phonetic utterance of the user intended to cause the voice-controlled terminal to react. The voice model provided by the voice model server and received by the voice-controlled terminal enables the voice-controlled terminal to recognize a voice command in an audio file as independent as possible of the user's speech pattern. To do this, the voice model must have a far-reaching universality with regard to the possible speech patterns of users of voice-controlled terminals.

Universality is achieved by training the voice model using a plurality of audio files that include voice commands from users. Of course, the level of universality achieved depends on the number and variety of audio files used for training.

The more users use voice-controlled terminals and the longer the use of the voice-controlled terminal lasts, the more audio files are transmitted to the central voice model server and can be used for training. In this way, the level of universality achieved can increase over time.

However, statutory provisions forbid an indefinite storing of the transmitted audio files. Rather, the audio files must be deleted after a maximum permissible storage period and are therefore no longer available for training the voice model after deletion. Accordingly, after the maximum permissible storage period, the voice model forgets the speech patterns corresponding to the deleted audio files, which is undesirable.

### SUMMARY

In an embodiment, the present disclosure provides a method for operating a central voice model server for a voice-controlled terminal, the method comprising: by a voice-controlled terminal, capturing a voice command of a user of the voice-controlled terminal and transmitting a primary audio file comprising the captured voice command to a central voice model server associated with the voice-controlled terminal; by a voice control of the voice-controlled terminal, recognizing the voice command in the provided primary audio file using a voice model received from the central voice model server and causing a reaction of the terminal corresponding to the recognized voice command; storing, by the central voice model server, the transmitted primary audio file in a buffer memory of the central voice model server; synthetically generating, by a synthesis module of the central voice model server, respective secondary audio files from randomly designated groups of primary audio files stored in the buffer memory and transmitted by the voice-controlled terminal; training, by a training module of the central voice model server, the voice model exclusively with the generated secondary audio files; and transmitting, by the central voice model server, the trained voice model to the voice-controlled terminal.

### BRIEF DESCRIPTION OF THE DRAWINGS

Subject matter of the present disclosure will be described in even greater detail below based on the exemplary FIGURES. All features described and/or illustrated herein can be used alone or combined in different combinations. The features and advantages of various embodiments will become apparent by reading the following detailed description with reference to the attached drawings, which illustrate the following:

FIG. 1 shows in a block diagram a central voice model server according to an embodiment of the invention for a voice-controlled terminal.

### DETAILED DESCRIPTION

In an embodiment, the present invention provides a method for operating a central voice model server for a voice-controlled terminal, which on the one hand complies with statutory provisions and on the other hand ensures that a voice model does not forget a learned speech pattern trained by the central voice model server. Embodiments of the invention provide a central voice model server for a voice-controlled terminal and a computer program product.

In an embodiment, the present invention provides a method for operating a central voice model server for a voice-controlled terminal, in which a voice-controlled terminal captures a voice command of a user of the voice-controlled terminal and transmits a primary audio file comprising the captured voice command to a central voice model server associated with the voice-controlled terminal, a voice control of the voice-controlled terminal recognizes the voice command in the provided primary audio file by means of a voice model received from the central voice model server and causes a reaction of the terminal corresponding to the recognized voice command. The central voice model server may be associated with further voice-controlled terminals that are different from said voice-controlled terminal. Typically, the central speech model server is assigned to a large plurality of voice-controlled terminals.

Generally, the audio file is a digital binary file and comprises a plurality of samples of a sound signal captured by a microphone on the voice-controlled terminal. The captured sound signal is sampled periodically by the voice-controlled terminal, wherein a period duration corresponds to a sampling frequency, or more precisely, is the reciprocal of the sampling frequency.

Generally, the voice model is a digital binary file and is used by the voice control to recognize a bit pattern in the primary audio file corresponding with sufficient accuracy to one or more predetermined command words associated with a reaction of the voice-controlled terminal and which command words are included in the captured voice command of the user. Recognizing the bit pattern is herein referred to as recognizing the voice command. The voice control is herein described as a module of the voice-controlled terminal.

Alternatively or additionally and also within the scope of the invention, the voice model server may comprise the voice control and may be designed to apply the voice model to the transmitted primary audio file, recognize the voice command and transmit the recognized voice command to the voice-controlled terminal.

According to the present invention, the central voice model server stores the primary audio file in a buffer memory of the central voice model server and a synthesis module of the central speech model server synthetically generates respective secondary audio files from randomly determined groups of primary audio files stored in the buffer memory and transmitted by speech-controlled terminals, a training module of the speech model server trains the speech model exclusively with the generated secondary audio files, and the central speech model server transmits the trained speech model to the speech-controlled terminal. The voice model is not trained with the transmitted primary audio files. The generated secondary audio files decouple the training from the transmitted primary audio files.

None of the synthetically generated secondary audio files can be associated with an individual user of a voice-controlled terminal. The synthetically generated secondary audio files are anonymous and are not subject to being prohibited by statutory provisions. Randomly designating the groups further increases the level of anonymity of the synthetically generated secondary audio files. In this way, the conformity of the method with the statutory provisions is ensured.

Preferably, the central voice model server designates at least three stored primary audio files as a group. The stated minimum size of a group further increases the level of anonymity.

A categorization module of the central voice model server can assign a plurality of values associated with respective predetermined categories to each stored primary audio file and designate the group dependent on the assigned values. Each assigned value indicates a variety of the primary audio file within the respective category. The respectively assigned values enable a comparison of primary audio files, in particular, determining a similarity or dissimilarity of the primary audio files with respect to the corresponding speech patterns. The assigned values can be understood as meta data of the primary audio files identified by the categorization module.

Advantageously, the predetermined categories comprise a gender of the user, a dialect of the user, an age of the user, a voice pitch of the user, a speaking speed of the user, a speaking rhythm of the user, a speaking dynamics of the user and/or a speaking melody of the user. This list is merely exemplary and not exhaustive. Each predetermined category corresponds to a feature of the speech pattern and contributes to an evaluation of the corresponding speech pattern. The voice pitch includes a fundamental frequency and an overtone spectrum (timbre) of the voice command. The voice dynamics comprise a volume range of the voice command. The voice melody includes a temporal variability in the voice pitch, for example, a voice pitch at the beginning of the voice command or a voice pitch at the end of the voice command.

In an embodiment, the primary audio files of a group are designated such that a match value determined as a function of the assigned values is greater than or equal to a predetermined match threshold value and/or pairwise differences of values assigned to the same category are less than a predetermined deviation threshold value. The match threshold value determines a minimum similarity of the primary audio files in a group. For example, the match threshold value can be 80% or more than 80%, so that each designated group comprises audio files which are at least 80% similar to each other.

The deviation threshold value determines a maximum dissimilarity of the primary audio files of a group in relation to a single category. For example, the deviation threshold value in the category “user's gender” can be 5% or less than 5%, so that gender differences within the group are highly unlikely and thus practically impossible. In this case, it is ensured that each designated group represents exclusively male or exclusively female speech patterns.

Preferably, the identified match value is increased by replacing a primary audio file of the group with largest pairwise differences from values assigned to the same category of further primary audio files of the group by a randomly determined primary audio file different from each primary audio file of the group. In other words, the largest differences are gradually reduced by means of an iteration until the determined match value reaches or exceeds the predetermined match threshold.

The central speech model server can store the primary audio file transmitted by the terminal temporarily and/or subject to a consent by the user in the buffer memory and/or each secondary audio file permanently in a training memory of the speech model server. Each primary audio file can be deleted from the buffer memory, i.e., may be only temporarily stored in the buffer memory, when it has been used at least once for synthetically generating a secondary audio file as member of a designated group. The at least one synthetically generated secondary audio file preserves the speech pattern corresponding to the primary audio file. Deleting a primary audio file before using it is, in particular, disadvantageous when the speech pattern corresponding to the deleted primary audio file deviates greatly from an average, i.e., normal speech pattern, i.e., it is exotic.

Of course, statutory provisions may require the user to consent to any storage of a primary audio file corresponding to their voice command, regardless of the storage period. In this case, the speech model cannot be trained with the user's speech pattern. In contrast, when the statutory provisions define a maximum consent-free storage period, primary audio files of each user can be used for synthetically generating secondary audio files during the defined maximum consent-free storage period.

By permanently storing the synthetically generated secondary audio files, which can also be referred to as synthesized training files or training files for short, the speech pattern corresponding to the primary audio file is preserved and can be used permanently to train the speech model. This way, the voice model does not forget learned speech patterns, which goes hand in hand with a continuously improved recognition of voice commands in the audio file.

In many embodiments, a voice assistant or a mobile terminal as the voice-controlled terminal captures the voice command. The voice assistant can also be referred to as voice-controlled assistance device. The voice-controlled terminal may be designed as a smartphone, a tablet, a notebook or the like.

In an embodiment, the invention provides a central voice model server for a voice-controlled terminal. The central voice model server continuously generates and updates, i.e., repeatedly trains, a voice model and provides the generated or updated voice model for use by voice-controlled terminals.

According to the invention, the central voice model server is configured to execute a method according to an embodiment of the invention. In this way, the voice model server is compliant with statutory provisions and at the same time ensures that a voice model trained by the central voice model server does not forget a learned speech pattern.

In an embodiment, the invention provides a computer program product comprising a digital storage medium with a program code. The digital storage medium is, by way of example and not limiting, designed as a CD (compact disk), a DVD (digital versatile disk), a USB (universal serial bus) stick, a hard disk (HD), a memory chip (random access memory, RAM), an Internet cloud or the like.

According to the invention, the program code causes a computing device to execute a method according to an embodiment of the invention as the central language model server when executed by a processor of the computing device. The computer program product, in cooperation with a computing device, commonly referred to as a computer, enables implementing a compliant speech model server that generates or continuously updates a speech model that does not forget a learned speech pattern, resulting in continuously improved recognition of speech commands in audio files.

An advantage of the method according to the invention is that an ability of voice-controlled terminals to recognize voice commands from users is continuously improved, thereby increasing user acceptance of the voice-controlled terminals.

It is understood that the above-mentioned features and those to be explained below can be used not only in the combination specified in each case, but also in other combinations or on their own, without departing from the scope of the present invention.

The invention is illustrated schematically in the drawings by means of an exemplary embodiment and is described in detail below with reference to the drawings. In the FIGURES:

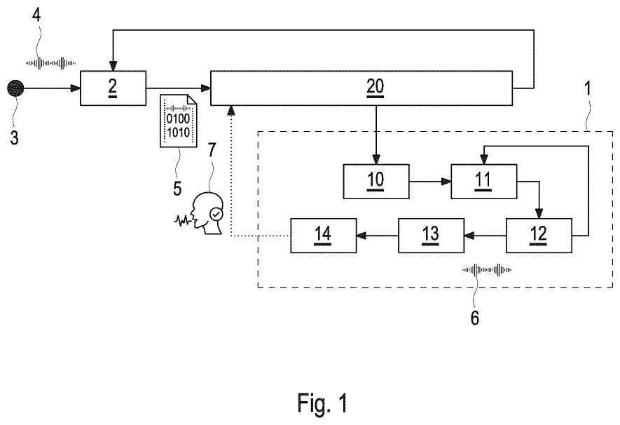

FIG. 1 shows in a block diagram a central voice model server 1 according to an embodiment of the invention for a voice-controlled terminal 2. The central voice model server 1 comprises a buffer memory 10, a synthesis module 12 and a training memory 14. The central voice model server 1 may further comprise a categorizing module 11 and a training memory 13.

The voice-controlled terminal 2 may comprise a voice control 20. The central voice model server 1 is configured to execute a method according to an embodiment of the invention described below as follows.

The central voice model server 1 may, in particular, be implemented by means of a computer program product comprising a digital storage medium with a program code. The program code causes a computing device to execute the method according to the invention as the central voice model server 1 when said program code is executed by a processor of the computing device.

The voice model server 1 for the voice-controlled terminal 2 is operated as follows.

The voice-controlled terminal 2, such as a voice assistant or a mobile terminal, captures a voice command 4 of a user 3 of the voice-controlled terminal 2 and transmits a primary audio file 5 comprising the captured voice command 4 to a central voice model server 1 which is assigned to the voice-controlled terminal 2.

The voice control 20 of the voice-controlled terminal 2 recognizes the voice command 4 in the provided primary audio file 5 by means of a voice model 7 received from the central voice model server 1 and causes a reaction of the terminal 2 corresponding to the recognized voice command 4.

The central voice model server 1 stores the transmitted primary audio file 5 in the buffer memory 10 of the central voice model server 1. In particular, the central voice model server 1 can store the primary audio file 5 transmitted by the terminal 2 temporarily and/or subject to a consent of the user 3 in the buffer memory 10. The categorization module 11 of the central voice model server 1 can assign a plurality of values associated with respective predetermined categories to each stored primary audio file 5.

The predetermined categories may comprise a gender of a user 3, a dialect of a user 3, an age of a user 3, a voice pitch of a user 3, a speaking speed of a user 3, a speaking rhythm of a user 3, a speaking dynamics of a user 3 and/or a speaking melody of a user 3.

The central speech model server 1 randomly and, in particular, dependent on the assigned values designates groups of primary audio files 5, which are stored in the buffer memory 10 and transmitted by voice-controlled terminals 2.

Preferably, the primary audio files 5 of a group are designated such that a match value determined dependent on the assigned values is greater than or equal to a predetermined match threshold value. Alternatively or additionally, the primary audio files 5 of a group can be designated such that pairwise differences of values assigned to the same category are less than a predetermined deviation threshold value.

The identified match value can be increased by replacing a primary audio file 5 of the group with largest pairwise differences to further primary audio files 5 of the group by a randomly determined primary audio file 5 different from each primary audio file 5 of the group.

The synthesis module 12 of the central voice model server 1 synthetically generates respective secondary audio files 6 from the randomly designated groups of primary audio files 5. Preferably, the central voice model server 1 designates at least three stored primary audio files 5 as a group.

Further preferably, the voice model server 1 stores each generated secondary audio file 6 permanently in the training memory 13 of the central voice model server 1.

The training model 14 of the central voice model server 1 trains the voice model 7 exclusively with generated secondary audio files 6. The central voice model server 1 transmits the trained voice model 7 to the voice-controlled terminal 2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Voice model server
10 Buffer memory
11 Categorization module
12 Synthesis module
13 Training memory
14 Training module
2 Voice-controlled terminal
20 Voice control
3 User
4 Voice command
5 Primary audio file
6 Secondary audio file
7 Voice model

1. A method for operating a central voice model server for a voice-controlled terminal, the method comprising:
by a voice-controlled terminal, capturing a voice command of a user of the voice-controlled terminal and transmitting a primary audio file comprising the captured voice command to a central voice model server associated with the voice-controlled terminal;
by a voice control of the voice-controlled terminal, recognizing the voice command in the provided primary audio file using a voice model received from the central voice model server and causing a reaction of the terminal corresponding to the recognized voice command;
storing, by the central voice model server, the transmitted primary audio file in a buffer memory of the central voice model server;
synthetically generating, by a synthesis module of the central voice model server, respective secondary audio files from randomly designated groups of primary audio files stored in the buffer memory and transmitted by the voice-controlled terminal;
training, by a training module of the central voice model server, the voice model exclusively with the generated secondary audio files; and
transmitting, by the central voice model server, the trained voice model to the voice-controlled terminal.

2. The method according to claim 1, wherein the central voice model server designates at least three stored primary audio files as a group.

3. The method according to claim 1, wherein a categorizing module of the central voice model server assigns to each stored primary audio file a plurality of values that are assigned to respective predetermined categories and designates the group dependent on the assigned values.

4. The method according to claim 3, wherein the predetermined categories comprise a gender of a user, a dialect of a user, an age of a user, a voice pitch of a user, a speaking speed of a user, a speaking rhythm of a user, a speaking dynamics of a user and/or a speaking melody of a user.

5. The method according to claim 1 wherein the primary audio files of a group are designated such that a match value determined as a function of the assigned values is greater than or equal to a predetermined match threshold value and/or pairwise differences of values assigned to the same category are less than a predetermined deviation threshold value.

6. The method according to claim 1, wherein the identified match value is increased by replacing a primary audio file of the group with largest pairwise differences to further primary audio files of the group by a randomly determined primary audio file different from each primary audio file of the group.

7. The method according to claim 1, wherein the central speech model server stores the primary audio file transmitted by the terminal temporarily and/or subject to a consent by the user in the buffer memory and/or each secondary audio file permanently in a training memory of the speech model server.

8. The method according to claim 1, wherein a voice assistant or a mobile terminal as the voice-controlled terminal captures the voice command.

9. The central voice model server for a voice-controlled terminal which is configured to be operated in a method according to claim 1.

10. The non-transitory computer readable medium comprising a digital memory device having a program code stored thereon which causes a computing device to execute a method according to claim 1 as the central voice model server when is the program code is executed by a processor of the computing device.
